(19) United States
(12) Patent Application Publication
(10) Pub. No.: US 2014/0102276 A1
(43) Pub. Date: Apr. 17, 2014

(54) Composite Saw Blades

(71) Applicant: Irwin Industrial Tool company, Huntersville, NC (US)

(72) Inventors: Mark J. Wysk, Monson, MA (US); Arthur C. Reardon, Wilbraham, MA (US)

(73) Assignee: Irwin Industrial Tool company, Huntersville, NC (US)

(21) Appl. No.: 14/055,498

(22) Filed: Oct. 16, 2013

Related U.S. Application Data
(63) Continuation of application No. 12/173,734, filed on Jul. 15, 2008, now abandoned.

(51) Int. Cl. B23D 61/12; B23B 51/04

(52) U.S. Cl. CPC B23D 61/127; B23D 61/128; B23B 51/0406
USPC 83/661; 83/835; 408/204

(57) ABSTRACT

Saw blades, including band saw blades, reciprocating saw blades, hole saw blades and hand hack saw blades, are made from a bi-metal strip. The bi-metal strip includes a cutting edge defined by a plurality of cutting teeth that is welded to an axially-elongated carbon or spring steel backing. The cutting edge is formed of a high speed steel alloy consisting essentially of: about 8/10% to about 1% carbon, up to about 45/100% silicon, up to about 4/10% manganese, up to about 3/100% phosphorous, up to about 3/100% sulfur, about 4% to about 6% cobalt, about 3% to about 5% chromium, about 4-1/2% to about 5-1/2% molybdenum, about 1% to about 2-1/2% vanadium, about 5-1/2% to about 7% tungsten, and about 74% to about 78-1/2% iron.

### CROSS-REFERENCE TO RELATED APPLICATIONS

This application is a continuation of co-pending U.S. patent application Ser. No. 12/173,734, filed Jul. 15, 2008, which is hereby expressly incorporated by reference in its entirety as part of the present disclosure.

### FIELD OF THE INVENTION

The present invention relates generally to saw blades and, more particularly, to composite band saw, jigsaw, hand hack saw, hole saw and reciprocating saw blades made from a bi-metal strip having a steel backing and a high speed steel cutting edge.

### BACKGROUND

Conventional composite saw blades are made by welding a high speed steel edge to a carbon steel backing. The edge is then machined to form a cutting edge defining by a plurality of cutting teeth. Many prior art composite saw blades use a high speed steel alloy sold by Simonds® International, Do-All® Sawing Products, Starrett®, Lenox® and others under the designation “M42”. One of the drawbacks of the M42 alloy is that it is relatively expensive due its high concentration of cobalt and molybdenum, resulting in composite saw blades that are relatively expensive to manufacture and retail, especially in today's global driven marketplace. A further drawback is that composite blades using the M42 alloy can exhibit less than desirable cutting performance and blade life characteristics.

Accordingly, it is an object of the present invention to overcome one or more of the above described drawbacks and/or disadvantages of the prior art.

### SUMMARY OF THE INVENTION

The present invention is directed to composite saw blades. The saw blades comprise an axially elongated steel backing and a high speed steel edge welded to the steel backing. The high speed steel edge defines a plurality of cutting teeth and is formed of a high speed steel alloy consisting essentially of: about 8/10% to about 1% carbon, up to about 45/100% silicon, up to about 4/10% manganese, up to about 3/100% phosphorous, up to about 3/100% sulfur, about 4% to about 6% cobalt, about 3% to about 5% chromium, about 4-1/2% to about 5-1/2% molybdenum, about 1% to about 2-1/2% vanadium, about 5-1/2% to about 7% tungsten, and about 74% to about 78-1/2% iron. In one embodiment, the steel backing is made of carbon steel and/or spring steel backing. The saw blades of the type herein described include band saw, jigsaw, hand hack saw, hole saw and reciprocating saw blades.

One advantage of the composite saw blades of the present invention is that they can be less expensive to manufacture in comparison to the above-described prior art saw blades.

Another advantage of the composite saw blades of the present invention is that they exhibit superior cutting performance and blade life characteristics in comparison to the above-described prior art composite saw blades.

Other objects, advantages and features of the present invention and of the currently preferred embodiments thereof will become more readily apparent in view of the following detailed description of the currently preferred embodiments and accompanying drawings.

### BRIEF DESCRIPTION OF THE DRAWINGS

FIG. 1 is a partial side view of a composite band saw blade according to an embodiment of the invention.

FIG. 2 is a side view of a composite jigsaw blade according to an embodiment of the invention.

FIG. 3 is a side view of a composite hand hack saw blade according to an embodiment of the invention.

FIG. 4 is a side view of a composite hole saw blade according to an embodiment of the invention.

FIG. 5 is a side view of a composite reciprocating saw blade according to an embodiment of the invention.

FIG. 6 is a flow chart illustrating conceptually a method of making the composite saw blades of the present invention.

FIG. 7 is an illustration of the high speed steel edge being welded to the steel backing to form the composite strip according to an embodiment of the invention.

FIG. 8 is a table showing test results of an embodiment of the hand hack saw blade of FIG. 3 in comparison to prior art hand hack saw blades.

FIG. 9 is a table showing test results of an embodiment of the band saw blade of FIG. 1 in comparison to prior art hand hack saw blades.

FIG. 10 is a table showing test results of an embodiment of the band saw blade of FIG. 1 in comparison to prior art hand hack saw blades.

### DETAILED DESCRIPTION OF THE CURRENTLY PREFERRED EMBODIMENTS

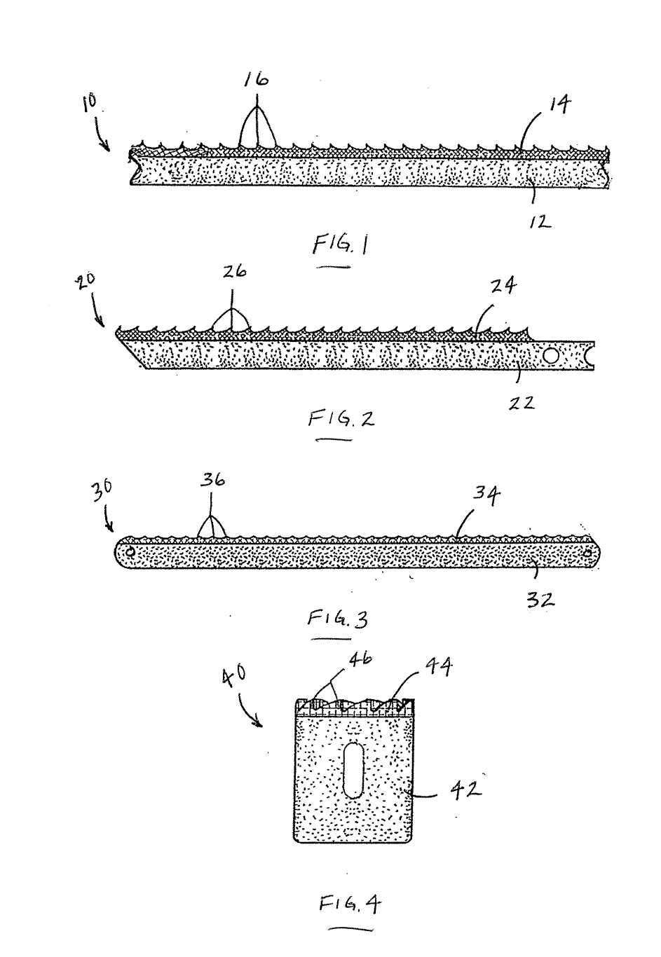

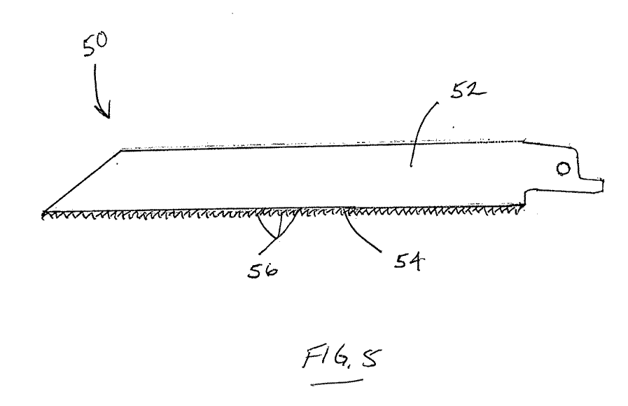

In FIGS. 1-5, composite saw blades embodying the present invention are indicated generally by the reference numerals 10, 20, 30, 40 and 50, respectively, wherein blade 10 is a band saw blade, blade 20 is a jigsaw blade, blade 30 is a hand held hack saw blade, blade 40 is a hole saw blade and blade 50 is a reciprocating saw blade. Each saw blade 10, 20, 30, 40 and 50 comprises an axially elongated carbon or spring steel backing 12, 22, 32, 42 and 52 and a high speed steel cutting edge 14, 24, 34, 44 and 54 welded to the steel backing and defined by a plurality of cutting teeth 16, 26, 36, 46 and 56. The cutting edge is formed from a high speed steel alloy consisting essentially by weight percentage of about 8/10% to about 1% carbon, up to about 45/100% silicon, up to about 4/10% manganese, up to about 3/100% phosphorous, up to about 3/100% sulfur, about 4% to about 6% cobalt, about 3% to about 5% chromium, about 4-1/2% to about 5-1/2% molybdenum, about 1% to about 2-1/2% vanadium, about 5-1/2% to about 7% tungsten, and about 74% to about 78-1/2% iron.

The composite saw blades 10, 20, 30, 40 and 50 are typically formed from a bi-metal or composite strip 100, illustrated in FIG. 7. The composite strip 100 comprises an axially elongated strip of carbon or spring steel backing material 112 to which high a speed steel edge material strip or wire 124 having the above-described composition is welded. However, as may be recognized by those skilled in the pertinent art based on the teachings herein, the composite saw blades 10, 20, 30, 40 and 50 may be manufactured individually in piece form as opposed to being manufactured from a composite strip.

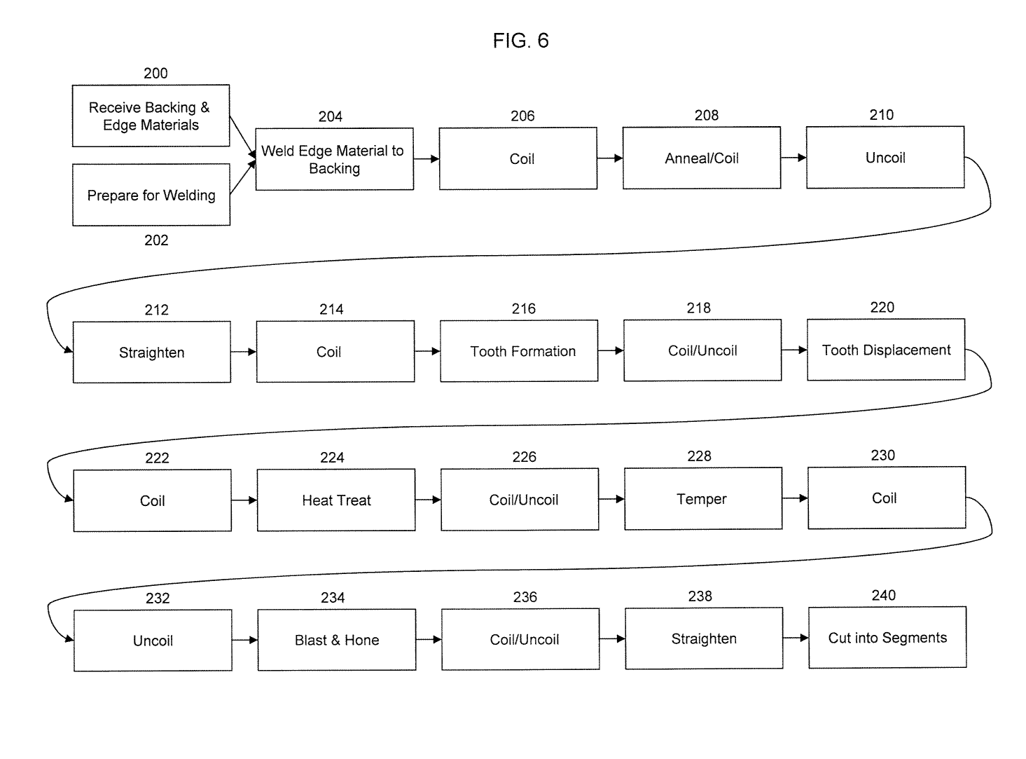

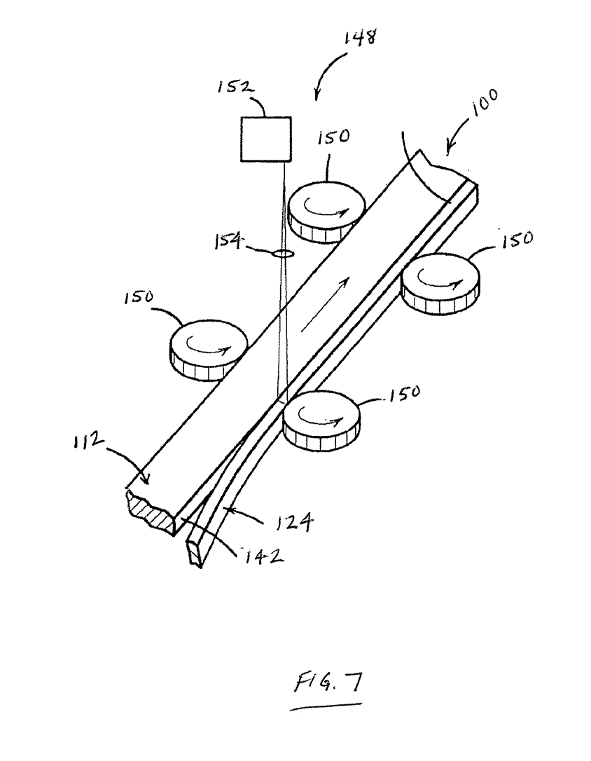

Turning to FIG. 6, a method of making the composite saw blades 10, 20, 30, 40 and 50 is hereinafter described in further detail. As shown at steps 200 and 202, the steel backing material 112 in strip form, for example, and the high speed steel edge material 124 in strip or wire form, for example, are received and prepared for welding in a manner known to those of ordinary skill in the pertinent art. At step 204, the high speed steel edge material 124 is welded to an edge 142 of the backing material 112 to form the composite strip 100. As shown in FIG. 7 by way of one example, a typical welding apparatus 148 includes opposing rollers 150 laterally spaced relative to each other for butt joining the high speed steel edge material 124 to an edge 142 of the backing material 112, and rotatably driving the composite or bi-metal strip 100 through the welding apparatus. A thermal energy source 152 is mounted within the welding apparatus 148 and applies thermal energy to the interface of the high speed steel 124 and front edge 142 of the backing material 112 to weld the high speed steel to the backing strip. In one embodiment of the present disclosure, the thermal energy source 152 transmits an electron beam 154 onto the interface of the high speed steel and backing material to electron beam the high speed steel to the backing material. However, as may be recognized by those skilled in the pertinent art based on the teachings herein, any of numerous other energy sources and/or joining methods that or currently or later become known for performing the functions of the electron beam welding apparatus may be equally employed to manufacture the saw blades of the present invention. For example, the energy source for welding the high speed steel edge material 124 to the backing material 112 may take the form of a laser or other energy source, and welding processes other than electron beam welding may be equally used.

As shown at step 206 of FIG. 6, after welding the high speed steel 124 to the backing material 112 and forming the composite strip 100, the composite strip 100 may then be coiled for annealing and/or for transporting the strip 100 to an annealing station. As shown at step 208, the composite strip 100 is annealed in a manner known to those of ordinary skill in the pertinent art. After annealing, the composite strip 100 is then uncoiled, if necessary, as shown at step 210, and the strip is straightened, as shown at step 212. After welding and annealing, the composite strip 100 may develop a camber or other undesirable curvatures, and therefore such curvatures must be removed prior to further processing.

As shown at step 214, the straightened composite strip 100 may be coiled again, if necessary, for transportation and further processing. At step 216, the composite strip 100 undergoes a tooth formation process, in which a plurality of cutting teeth (see, for example 16, 26 36, 46 and 56 of FIGS. 1-5) are formed in a portion of the composite strip including the high speed steel edge. Upon completion of the tooth formation process, the composite strip 100 may be coiled and uncoiled again, if necessary, for further processing, as indicated at step 218. Next, at step 220, the teeth undergo a displacement process, whereby the teeth are set into a desired tooth pattern.

After the teeth are set, the composite strip 100 may be coiled again at step 222, if necessary, for transportation to a heat treating station and, at step 224, the composite strip 100 is heat treated. As may be recognized by those of ordinary skill in the pertinent art based on the teachings herein, the heat treating operation may be performed in accordance with any of numerous different heat treating processes and combinations thereof that are currently known, or later become known for heat treating articles like the composite strip 100. In one embodiment of the present invention, the composite strip 100 is heat treated at a temperature within the range of approximately 2100° F. to approximately 2250° F. and, in a preferred embodiment, the strip 100 is heat treated at a temperature within the range of approximately 2175° F. to approximately 2225° F. It should be noted that the composite strip 100 may be subjected to any number of heat treating cycles as may be required in order to obtain the desired physical characteristics of the resulting blades.

Upon completion of the heat treatment process, the composite strip 100 may be coiled and uncoiled again at step 226, if necessary, for transportation to a tempering station. At step 228 of FIG. 6, the strip 100 undergoes a tempering operation. As may be recognized by those of ordinary skill in the pertinent art based on the teachings herein, the tempering operation may be performed in accordance with any of numerous different tempering processes that are currently known, or later become known for tempering articles like the composite strip 100. Further, it should be noted that the composite strip 100 may be subjected to any number of tempering cycles as may be required in order to obtain the desired physical characteristics of the resulting blades.

At step 230, the heat treated and tempered composite strip 100 is coiled again, if necessary, for transportation to blasting and honing stations. At step 232, the heat treated and tempered composite strip 100 is uncoiled again, if necessary, and at step 234, the composite strip is subjected to blasting and honing. More specifically, the composite strip 100 is blasted to remove any unwanted burrs and to otherwise prepare the surfaces of the cutting teeth for honing. Next, the teeth are honed in a manner known to those of ordinary skill in the pertinent art to sharpen the cutting edges of the teeth which, in turn, forms a sharp wear-resistant high speed steel cutting edge on the respective saw blades 10, 20, 30, 40 and 50. At steps 236 and 238, the blasted and honed strip 100 is again coiled/uncoiled and straightened, if necessary.

Next, at step 240, the blasted and honed composite strip 100 is cut into segments, each segment corresponding to an individual blade of the type (10, 20, 30 or 40) being produced. The composite blades 10, 20, 30, 40 and 50 may then undergo further processing if desired or otherwise required. For example, to make the hole saw blade 40 each blade segment is rolled or otherwise formed into a cylindrical shape with its ends abutting or otherwise contacting each other, and the ends are welded to form a cylindrical hole saw body. Then, or as part of manufacturing the cylindrical hole saw body, the blade is welded or otherwise fixedly secured to an end plate or cap 48 (FIG. 4). It should be noted that the above-described method of manufacturing the composite blades of the present invention is but one example, and that those skilled in the pertinent art based on the teachings herein will recognize that any of numerous modifications can be made to any of the above steps based upon manufacturing methods that are currently known, or that later become known for manufacturing composite saw blades.

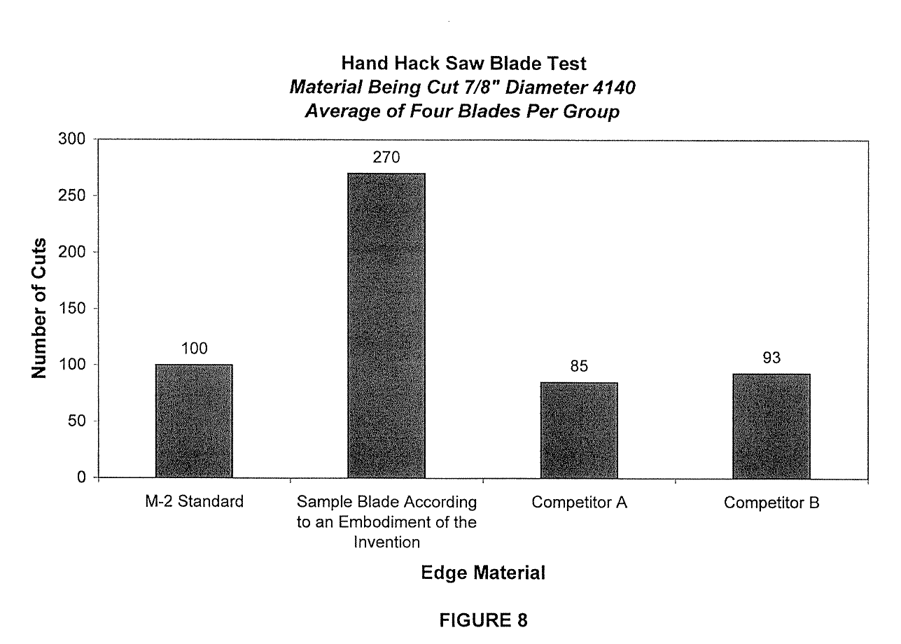

FIG. 8 illustrates test results for a hand hack saw blade according to an embodiment of the invention in comparison to hand hack saw blades having an edge material made from a standard M-2 steel alloy and two competitor's blades (i.e. Competitor A and Competitor B). The test was performed to determine the number of cuts each blade could perform on a ⅞ inch diameter 4140 steel sheet before failing. A “cut” as defined in the context of FIG. 8 refers to a complete cutting through of a predetermined portion of the material. Failure was determined by observing the amount of time, i.e., cutting time, required for a blade to cut through the predetermined portion of the material, and comparing the cutting time to a threshold cutting time. When the time required to make a complete cut of the material exceeded the threshold cutting time, the blade was considered to have failed. The blades were tested in groups of four blades per group, and the number of cuts that each blade performed before failing was averaged to produce the number of cuts listed in FIG. 8.

As can be seen, the hand hack saw blades according to an embodiment of the invention were able to make an average of 270 cuts before failing, whereas the standard M-2 blades were only able to make an average of 100 cuts before failing, Competitor A's blades were only able to make 85 cuts before failing and Competitor B's blades were only able to make 93 cuts before failing. Therefore, the blades according to an embodiment of the invention exhibited a 170% improvement in the number of cuts over the M-2 blades, a 217% improvement in the number of cuts over Competitor A's blades and a 190% improvement in the number of cuts over Competitor B's Blades.

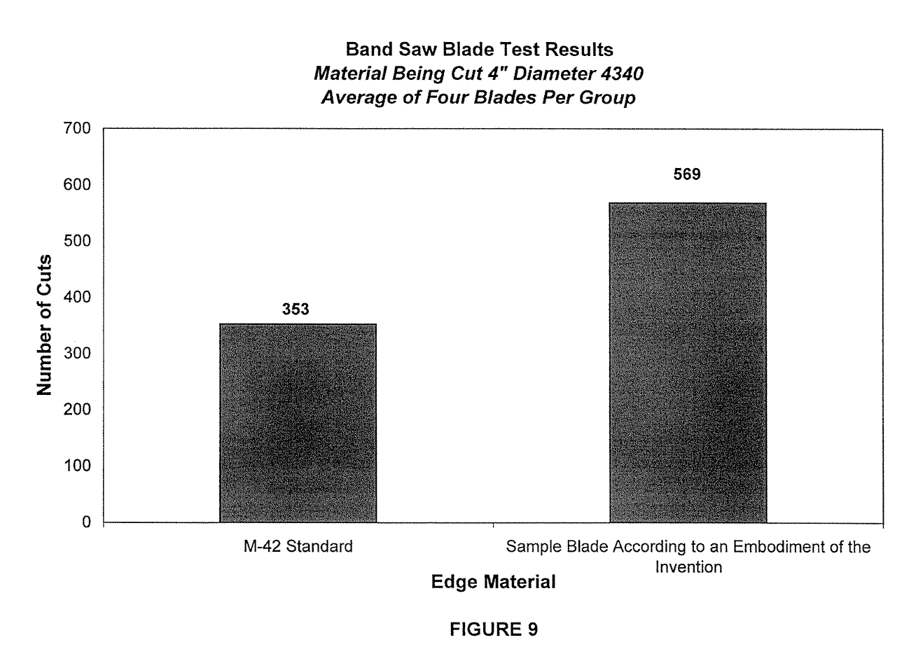

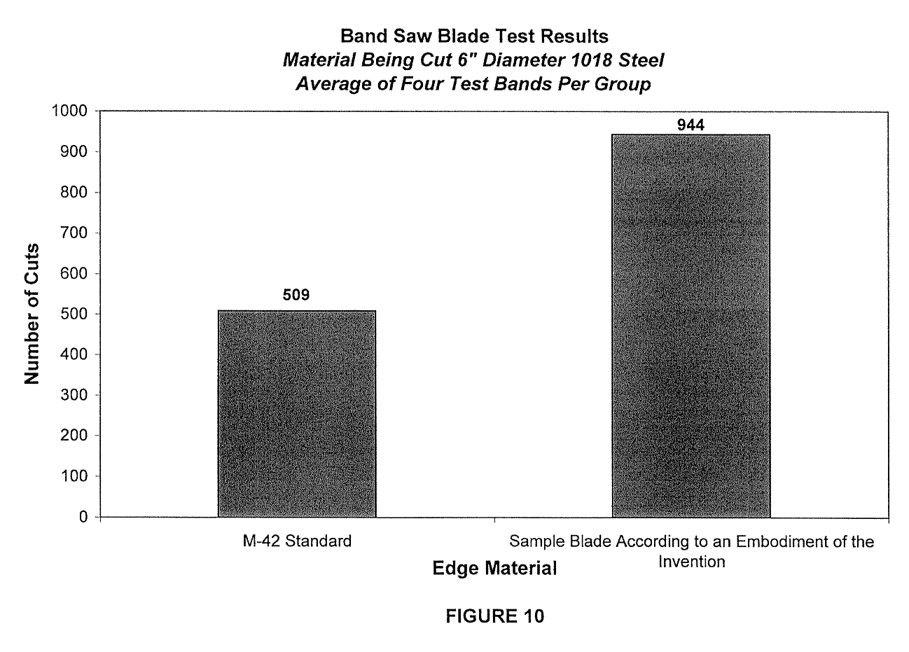

FIGS. 9 and 10 illustrate test results for band saw blades according to an embodiment of the invention in comparison to band saw blades having an edge material made from M-42 steel alloy. The tests were performed to determine the number of cuts each blade could perform on a 4 inch diameter 4340 steel sheet (FIG. 9) and a 6 inch diameter 1018 steel sheet (FIG. 10) before failing. A “cut” as defined in the context of FIGS. 9-10 refers to a complete cutting through of a predetermined portion of the material. Failure was determined by observing the amount of time, i.e., cutting time, required for a blade to cut through the predetermined portion of the material, and comparing the cutting time to a threshold cutting time. When the time required to make a complete cut of the material exceeded the threshold cutting time, the blade was considered to have failed. The blades were tested in groups of four blades per group, and the number of cuts that each blade performed before failing was averaged to produce the number of cuts listed in FIGS. 9-10.

As can be seen in FIG. 9, the band saw blades according to an embodiment of the invention were able to make an average of 569 cuts before failing, whereas the M-42 blades were only able to make an average of 353 cuts before failing. Therefore, the blades according to an embodiment of the invention exhibited a 61% improvement in the number of cuts over the M-42 blades. Further, as can be seen in FIG. 10, the band saw blades according to an embodiment of the invention were able to make an average of 944 cuts before failing, whereas the M-42 blades were only able to make an average of 509 cuts before failing. Therefore, the blades according to an embodiment of the invention exhibited a 85% improvement in the number of cuts over the M-42 blades.

Although test results are not provided for jigsaws, hole saws and reciprocating saws according to embodiments of the invention, as may be recognized by those of ordinary skill in the pertinent art based on the teachings herein, similar improvements in blade performance (i.e. the number of cuts before failing) are expected in comparison to blades having cutting edges made from M-2 and M-42 steel alloys.

As may be recognized by those of ordinary skill in the pertinent art based on the teachings herein, various changes and modifications may be made to the above-described and other embodiments of the present invention without departing from the scope of the invention as defined in the appended claims. For example, the backing strip may be formed of any of numerous different materials and may take any of numerous different configurations that are currently known or that later become known. Similarly, the cutting teeth may define any of numerous different tooth forms, set patterns, pitch patterns, or other saw blade teeth configurations that are currently known, or that later become known. In addition, the saw blades may take the form of any of numerous different types of composite or bi-metal saw blades that are currently known or that later become known, such as any of numerous different types of bi-metal saw blades made from bi-metal strips formed by a high speed steel alloy strip welded to a steel backing strip. Accordingly, this detailed description of the currently-preferred embodiments is to be taken in an illustrative, as opposed to a limiting sense.

What is claimed is:

1. A bi-metal saw blade comprising:
an axially elongated steel backing; and
a high speed steel edge welded to the steel backing and defining a plurality of cutting teeth, wherein the high speed steel edge is formed of an alloy consisting essentially of:
8/10% to 1% carbon;
up to about 45/100% silicon;
up to about 4/10% manganese;
up to about 3/100% phosphorous;
up to about 3/100% sulfur;
4% to 6% cobalt;
3% to 5% chromium;
4-1/2% to 5-1/2% molybdenum;
1% to 2-1/2% vanadium;
5-1/2% to 7% tungsten; and
74% to 78-1/2% iron.

2. A saw blade as defined in claim 1, wherein the steel backing is at least one of (i) a spring steel backing and (ii) a carbon steel backing.

3. A saw blade as defined in claim 1, wherein the saw blade is one of a band saw blade, a jigsaw blade, a reciprocating saw blade, a hand hack saw blade a hole saw blade and a reciprocating saw blade.

4. A bi-metal saw blade comprising:
first means for sawing a work piece formed of a high speed steel alloy consisting essentially of:
8/10% to 1% carbon;
up to about 45/100% silicon;
up to about 4/10% manganese;
up to about 3/100% phosphorous;
up to about 3/100% sulfur;
4% to 6% cobalt;
3% to 5% chromium;
4-1/2% to 5-1/2% molybdenum;
1% to 2-1/2% vanadium;
5-1/2% to 7% tungsten; and
74% to 78-1/2% iron; and
second means welded to the first means along an axially extending edge thereof for supporting and backing the first means during sawing a work piece.

5. A saw blade as defined in claim 4, wherein the first means is a cutting edge defining a plurality of saw teeth; and the second means is a steel backing strip welded to the high speed steel cutting edge.

6. A saw blade as defined in claim 4, wherein the saw blade is one of a band saw blade, a reciprocating saw blade, a hand hack saw blade and a hole saw blade.
